(19) United States
(12) Patent Application Publication
(10) Pub. No.: US 2026/0052376 A1
(43) Pub. Date: Feb. 19, 2026

(54) SYSTEMS AND METHODS FOR EVALUATING THE CONDITION OF A USER DEVICE

(71) Applicant: ON.XYZ Incorporated, Woodinville, WA (US)

(72) Inventor: Jordan Thomas Insley, Phoenix, AZ (US)

(21) Appl. No.: 18/807,494

(22) Filed: Aug. 16, 2024

(51) Int. Cl. H04W 8/24

(52) U.S. Cl. CPC H04W 8/24

(57) ABSTRACT

Systems, methods, and articles for evaluating user devices are described herein. The systems disclosed herein receive user device data form a user device that includes an identifier of the user device. The user device data is used to identify external user device data repositories that include user device data not stored on the user device. External user device data is received from the external user device data repositories. One or more conditions of the user device are determined based on the user device data and external user device data. A description of the user device is generated based on the external user device data and the user device data, and the description is caused to be presented to one or more users.

### BACKGROUND

### TECHNICAL FIELD

The present disclosure relates to the field of computer technology, and more particularly, to computer systems and methods that evaluate the condition of user devices.

### DESCRIPTION OF THE RELATED ART

User devices, such as cell phones, tablets, laptop computing devices, desktop computing devices, smart devices, or other devices, are typically transferred to other users secondhand, such as when a current user of a user device no longer needs, wants, or otherwise desires to possess the user device. Current users of a user device typically describe the user device to potential new users by utilizing one or more device information entities that may facilitate the transfer of the user device to a new user. Current methods of describing the user device require the user to manually describe the user device via a user interface of each device information entity used to describe the user device.

### BRIEF DESCRIPTION OF THE SEVERAL VIEWS OF THE DRAWINGS

FIG. 1 shows an example environment in which a device condition evaluation system may operate, according to various embodiments described herein.

FIG. 2 is a block diagram depicting a sample device condition evaluation system, according to various embodiments described herein.

FIG. 3 is a flow diagram of a process for evaluating the condition of a user device, according to various embodiments described herein.

FIG. 4 is a flow diagram of a process for using a machine learning model to generate a description of a user device, according to various embodiments described herein.

FIG. 5 is a flow diagram of a process for using a machine learning model to generate an overall condition of a user device, according to various embodiments described herein.

FIG. 6 is a flow diagram of a process for determining a resource cost for a user device, according to various embodiments described herein.

FIG. 7 is a flow diagram of a process for using a machine learning model to determine a resource cost for a user device, according to various embodiments described herein.

FIG. 8 is a flow diagram of a process for detecting whether a user device was altered from its original state, according to various embodiments described herein.

FIG. 9 shows a processor-based device suitable for implementing the various functionality described herein.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure are directed to computer-implemented systems and methods of evaluating user devices and displaying a description of the user device via one or more device information entities. Evaluating and describing user devices has traditionally been a manual process that requires a user to manually describe the user device via user interfaces associated with each device information entity on which a current user of a user device desires to display the information.

In conventional workflows a user manually generates a description of a user device via a user interface of associated with each device information entity on which a current user of a user device desires to display the information. However, in conventional workflows, a description of the user device may not include important information regarding the status of the condition of the user device. Furthermore, conventional workflows do not allow users to generate a uniform overall condition of the user device (which may be referred to as a “grade” of the user device) that quickly communicates the condition of the user device. This leads to confusion as to the condition of user devices that are transferred to new users, and may lead to proposed transfers that do not result in a successful transfer of the user device to a new user.

Implementations of the present disclosure are directed to computer-implemented systems and methods for evaluating user devices and displaying descriptions of the user devices via device information entities (a “user device evaluation system”). Thus, the aforementioned inefficient and unreliable processes are improved to provide better methods of generating accurate descriptions of the condition of user devices and displaying the descriptions of the user devices via device information entities.

Such implementations are thus able to improve the functioning of computer or other hardware, such as by reducing the processing, storage, and/or data transmission resources needed to perform a certain task, thereby enabling the task to be permitted by less capable, capacious, and/or expensive hardware device, and/or be performed with lesser latency, and/or preserving more of the conserved resources for use in performing other tasks. For example, by accurately determining and communicating the condition of user devices proposed transfers of user devices are more likely to succeed, thus resulting in fewer computing resources, such as processing power, memory, or other computer resources, being used to facilitate transfers of user devices to new users. In another example, by automatically generating a description of the condition of user devices, the user device evaluation system is able to generate and update descriptions of user devices in a faster and more accurate manner than conventional methods and systems.

In at least some implementations, the user device evaluation system generates, maintains, or some combination thereof, one or more machine learning models that determine an overall condition or “grade” of a user device, that generate a description of a user device, that generate a recommended resource cost for one or more user devices, or some combination thereof. In at least some implementations, the user device evaluation system automatically updates descriptions of user devices that are provided by device information entities.

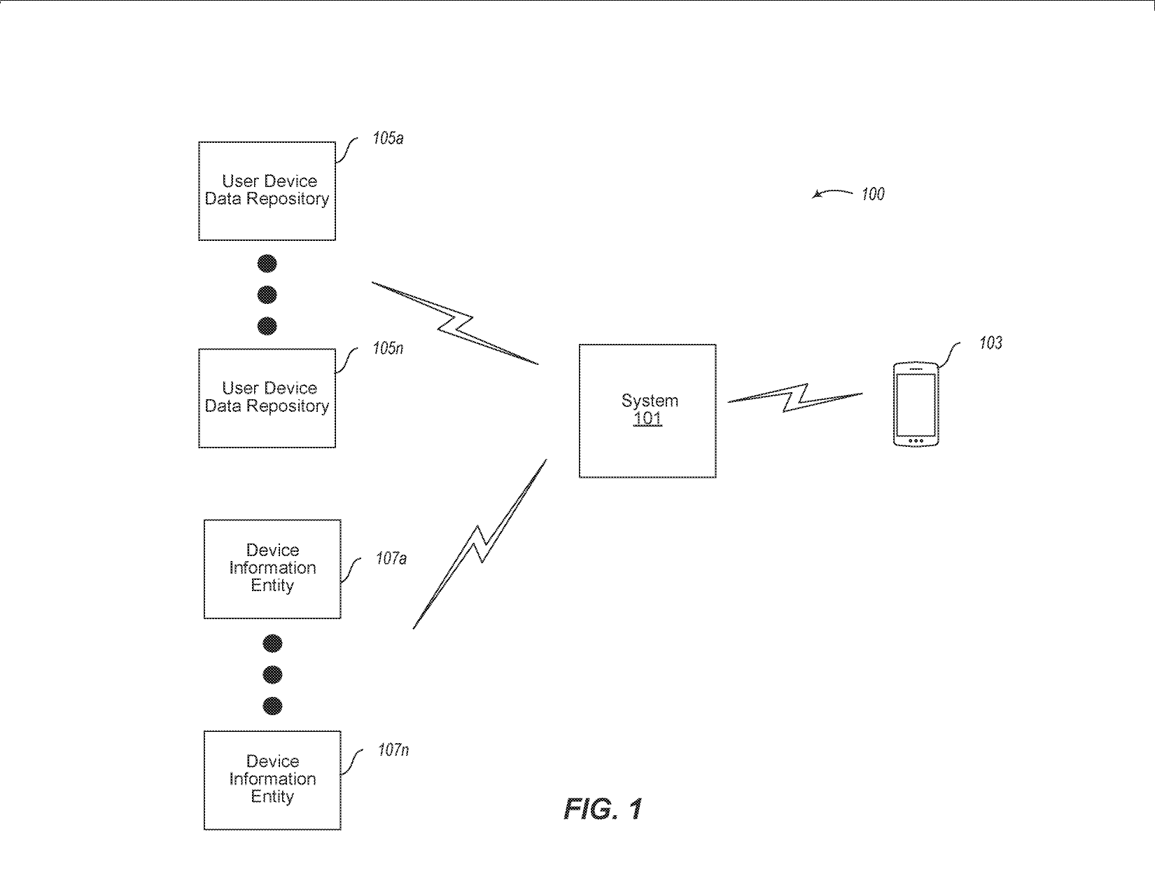

FIG. 1 shows an example environment 100 in which a user device evaluation system 101 may operate, according to various embodiments described herein. The environment 100 user device evaluation system 101 (a “system 101”), a user device 103, one or more user device data repositories 105a-105n (individually as “user device data repository 105” or collectively as “user device data repositories 105”), and one or more device information entities 107a-107n (individually as “device information entity 107” or collectively as “device information entities 107”).

The system 101 may receive user device data regarding a user device from the user device 103. In some embodiments, the system 101 establishes a connection with the user device 103, such as a wired or wireless connection. In some embodiments, the system 101 executes one or more data diagnostic tools, data erasure tools, other tools for receiving data regarding a condition of a user device or its components, or some combination thereof to obtain the user device data. The system 101 may additionally receive external user device data from one or more of the user device data repositories 105. The user device 103, system 101, user device data repositories 105, and device information entities 107 may transmit or receive data to or from each other via a wireless connection, a wired connection, the Internet or other computer networks, or via other methods of transmitting data to or from computing devices. The user device 103 may be a television, projector, PC, tablet, laptop computer, smartphone, telephone, personal assistant, drone, Internet connection device, vehicle, USB dongle, Mi-Fi device, or other types of user device.

The user device data repositories 105 may be one or more repositories of user device data that store data regarding the condition of a user device externally from the user device, such as data repositories associated with one or more of: a network carrier that provides a network connection to the user device, an original equipment manufacturer (“OEM”) of the user device, an OEM of one or more components of the user device, an organization associated with one or more mobile operators such as GSMA, other entities that store data associated with a condition of a user device, or some combination thereof. In some embodiments, the user device data repositories 105 may include data that indicates whether a user device is locked, blocklisted, able to operate with a selected network, stolen, lost, other conditions of the user device, or some combination thereof. In some embodiments, the user device data repositories may include data that indicates an original state of the user device, one or more components of the user device, or some combination thereof. In some embodiments, the data indicating the original state of the user device includes data indicating software that was present on the user device when the user device was first transferred to a user.

The device information entities 107 may be one or more entities that provide descriptions of one or more user devices to one or more users. In some embodiments, a device information entity 107 may facilitate the transfer of the user device to another user, such as via a marketplace for user devices. Examples of such entities may include auction marketplaces, secondary marketplaces, or other entities that facilitate the transfer of a user device to another user.

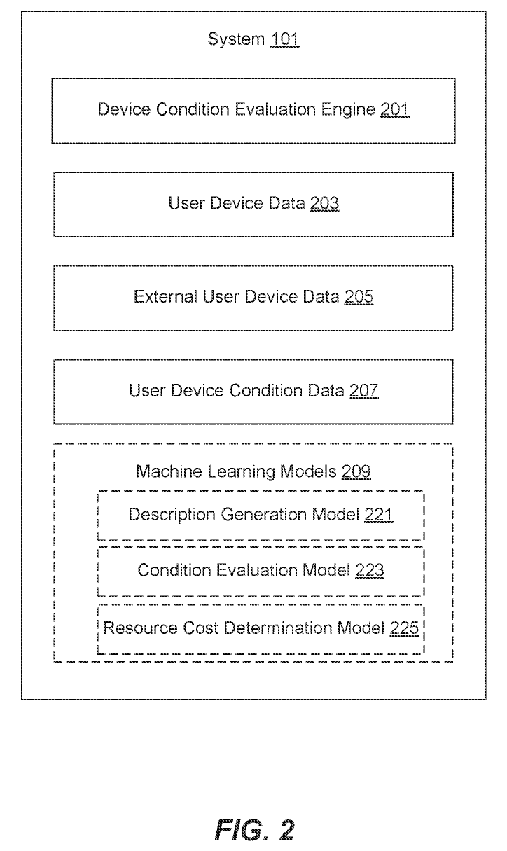

FIG. 2 is a block diagram depicting a sample user device evaluation system 101, according to various embodiments described herein. Aspects of the system 101 may operate on or include one or more computing devices, one or more servers, or any other combination of servers or computing devices. The system 101 may communicate with user devices, such as the user device 103; user device data repositories, such as the user device data repository 105; device information entities, such as the device information entities 107; or some combination thereof. The system 101 may be able to receive user input related to the functions of the system 101. The system 101 may include or have access to a display device, which may be used to display data generated by the system 101.

The system 101 includes a device condition evaluation engine 201, user device data 203, external user device data 205, user device condition data 207, as well as other data, engines, software applications, hardware, etc., which may be used to perform the function of the system 101. In some embodiments, the system 101 further includes one or more machine learning models 209, such as a description generation model 221, a condition evaluation model 223, and a resource cost determination model 225. The user device evaluation engine 201 may use the user device data 203, external user device data 205, the user device condition data 207, the machine learning models 209, or some combination thereof, to perform the operations or functions of the system 101 described herein, including the functions described with respect to any of the processes 300, 400, 500, 600, 700, and 800.

The user device data 203 includes data received from a user device, such as user device 103, related to the condition of the user device, the condition of the components of the user device, or some combination thereof. The user device data 203 may include one or more of: an indication of software running on the user device; an indication of the status of one or more components of the user device, such as the battery, screen, processor, memory, camera, other components of the user device, or some combination thereof; an indication of the data stored by the user device; an indication of one or more identifiers of the user device, such as an identifier assigned to the user device by one or more entities, a MAC address, a serial number of the user device, a model of the user device, an International Mobile Equipment Identity (IMEI) number associated with the user device, or other types of identifiers of a user device; an indication of the amount of time that the user device was in use, such as an amount of time that the user device was on, a number of phone calls made by the user device, a number of text messages sent or received by the user device, an indication of the condition of the battery of the user device, other data indicating the amount of time the user device was in use, or some combination thereof; metadata indicating one or more properties of the user device; other data associated with or stored on the user device; or some combination thereof. In some embodiments, the system 101 may obtain the user device data 203 by using one or more tools for determining the condition of a user device or a component. In such embodiments, the system 101 may connect to the user device via a wired connection, a wireless connection, or some combination thereof to use the one or more tools for determining the condition of the user device. In some embodiments, the system 101 receives at least a portion of the user device data 203 via user input. In some embodiments, the user device data 203 may include data included in the external user device data 205.

The external user device data 205 includes data associated with the user device received from one or more user device data repositories, such as the user device data repositories 105. The external user device data 205 may include data indicating whether the user device was lost or stolen; whether the user device was “locked” such that users other than a previous user are unable to use or access the user device; one or more networks to which the user device is able to access, such as a network associated with a telecommunications carrier, a wireless network, a wired network, other types of network, or some combination thereof; an indication of whether the user device is able to be altered to access one or more networks; other data available from a user device data repository; a date that the user device was manufactured; a date that one or more components of the user device were manufactured; a carrier associated with the user device; a status of one or more components of the user device, such as whether one or more components were replaced; an extent to which the user device was sued by a user of the user device; whether the user device was repaired or refurbished; or some combination thereof. In some embodiments, the external user device data 205 may include data included in the user device data 203. In some embodiments, the system 101 transmits an identifier of the user device, such as a serial number, to a user device data repository to obtain at least a portion of the external user device data 205.

The user device condition data 207 includes data associated with one or more conditions of the user device determined by the system 101. In some embodiments, the one or more conditions are based on one or more characteristics of the user device. In some embodiments, the user device condition data 207 includes data indicating an overall condition or “grade” of the user device; a condition of one or more components of the user device, such as the processor, memory, data storage, camera, screen, battery, wireless network antenna, charging port, headphone port, other components of the user device, or some combination thereof; other data indicating a condition of a user device, the user device components, or some combination thereof; or some combination thereof. In some embodiments, the system 101 generates the user device condition data 207 based on the user device data 203, the external user device data 205, other data, or some combination thereof. In some embodiments, the system 101 generates at least a portion of the user device condition data 207 based on a condition evaluation model, such as the condition evaluation model 223.

The machine learning models 209 may include statistical models, artificial intelligence, or machine learning models trained or generated by the system 101. In some embodiments, at least a portion of the statistical models, artificial intelligence, or machine learning models included in the machine learning models 209 may be generated by a system other than the system 101. The description generation model 221 may be a statistical model, artificial intelligence, machine learning model, or some combination thereof, trained or generated to output a description of a user device based on user device data, external user device data, other data, or some combination thereof. The condition evaluation model 223 may be a statistical model, artificial intelligence, machine learning model, or some combination thereof, trained or generated to output an overall condition or grade of a user device based on user device data, external user device data, other data, or some combination thereof. The resource cost determination model 225 may be a statistical model, artificial intelligence, machine learning model, or some combination thereof, trained or generated to output a proposed resource cost to transfer a user device to another user based on user device data, external user device data, data indicating resource costs for transferring a user device to another user, other data, or some combination thereof.

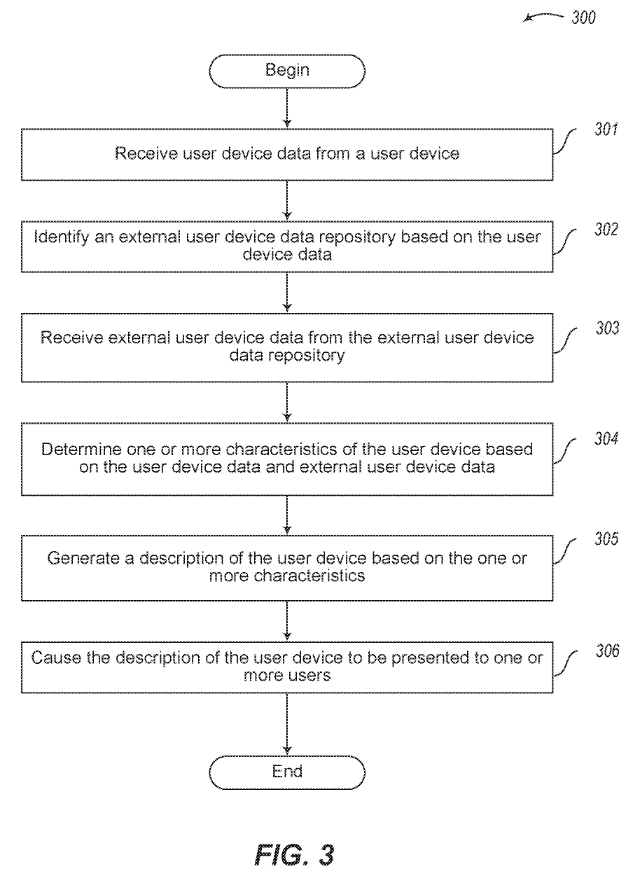

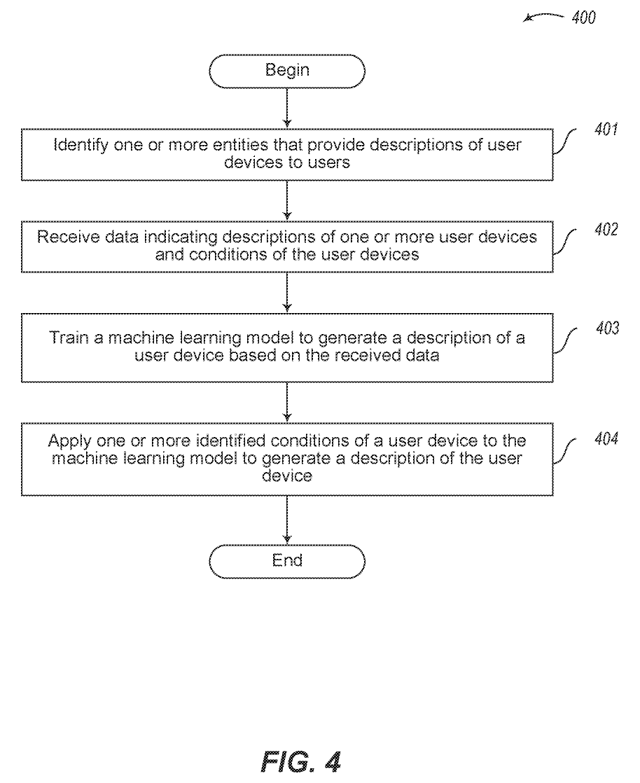

FIG. 3 is a flow diagram of a process 300 for evaluating the condition of a user device, according to various embodiments described herein. The process 300 may be performed by a user device evaluation system, such as the system 101 described above in connection with FIG. 2. In some embodiments, at least some of the aspects of the process 300 are performed by using one or more aspects of the processes 400, 500, 600, 700, and 800 described below in connection with FIGS. 4-8.

The process 300 begins, after a start block, at act 301, where the system receives user device data from a user device. In some embodiments, the user device data includes a serial number of the user device. In some embodiments, the system performs act 301 by connecting to the user device via a wired connection, a wireless connection, or some combination thereof.

The process 300 proceeds to act 302, where the system identifies an external user device data repository, such as a user device data repository 105 described above in connection with FIG. 1, based on the user device data. In some embodiments, the system may identify the external user data repository based on a model type of the user device, a serial number of the user device, a network carrier used by the user device, other data included in the user device data, or some combination thereof. In some embodiments, the system identifies multiple external user data repositories.

The process 300 proceeds to act 303, where the system receives external user device data from the external user device data repository. In some embodiments, the system may receive the external user device data in response to a transmission of an identifier of the user device to the external user device data repository.

The process 300 proceeds to act 304, where the system determines one or more characteristics of the user device based on the user device data and the external user device data. In some embodiments, the one or more characteristics of the user device may be used to identify one or more conditions of the user device. In some embodiments, as part of performing act 304, the system identifies a model of the user device based on the user device data. In such embodiments, the system may determine whether the model identified based on the user device data is correct based on the external user device data. In some embodiments, the one or more characteristics indicate: one or more networks that the user device is not able to access; whether the user device was stolen; a user that possessed the user device; a status of one or more components of the user device; a model of the user device; the overall condition of the user device; other conditions of a user device; or some combination thereof. In some embodiments, as part of performing act 304, the system uses a condition evaluation model, such as the condition evaluation model 223, described above in connection with FIG. 2.

The process 300 proceeds to act 305, where the system generates a description of the user device based on the one or more characteristics. In some embodiments, the system uses a machine learning model to generate the description of a user device, such as the description generation model 221, described above in connection with FIG. 2. In some embodiments, as part of performing act 305, the system uses a resource cost determination model, such as the resource cost determination model 225, described above in connection with FIG. 2. In some embodiments, the system generates a health report of the user device based on the one or more characteristics of the user device, the user device data, the external user device data, other data, or some combination thereof. In such embodiments, the health report includes a status of one or more components of the user device, an indication of the extent to which the user device was used by a user, or some combination thereof.

The process 300 proceeds to act 306, where the system causes the description of the user device to be presented to one or more users. In some embodiments, the system causes the description of the user device to be presented by transmitting the description to one or more device information entities, such as the device information entities 107 described above in connection with FIG. 1.

After act 306, the process 300 ends. In some embodiments, the system performs at least some of the acts of the process 300 multiple times. For example, the system may generate a new description of the user device after a selected period of time has passed. In such an example, the new description of the user device may be transmitted to one or more device information entities. Such an example embodiment may be used to update an aspect of the description of the user device, such as a resource cost included in the description, a condition of the user device, other aspects of the description of the user device, or some combination thereof.

FIG. 4 is a flow diagram of a process 400 for using a machine learning model to generate a description of a user device, according to various embodiments described herein. The process 400 may be performed by a user device evaluation system, such as the system 101 described above in connection with FIG. 2.

The process 400 begins, after a start block, at act 401, where the system identifies one or more entities that provide descriptions of user devices to users, such as one or more of the device information entities 107, described above in connection with FIG. 1.

The process 400 proceeds to act 402, where the system receives data indicating descriptions of one or more user devices and one or more characteristics of the user devices. In some embodiments, to perform act 402, the system receives data made available to the system by the one or more entities, such as by accessing data available in one or more data repositories of the one or more entities, data published on a website associated with the one or more entities, other methods of accessing data from an entity, or some combination thereof. In some embodiments, the system may access the data made available to the system by the one or more entities multiple times, such as periodically, after a selected period of time, etc.

The process 400 proceeds to act 403, where the system trains a machine learning model, such as the description generation model 221 described above in connection with FIG. 2, to generate a description of a user device based on the received data. In some embodiments, the machine learning model is a natural language model.

The process 400 proceeds to act 404, where the system applies one or more identified conditions of a user device to the machine learning model to generate a description of the user device.

After act 404, the process 400 ends.

In some embodiments, the system does not perform acts 401-403. In such embodiments, the system may use a machine learning model that has already been trained to generate text based on user input, such as a natural language model.

In some embodiments, the system retrains the machine learning model of the process 400. In such embodiments, the system may retrain the machine learning model in response to receiving new data indicating descriptions of one or more user devices and the conditions of the user devices.

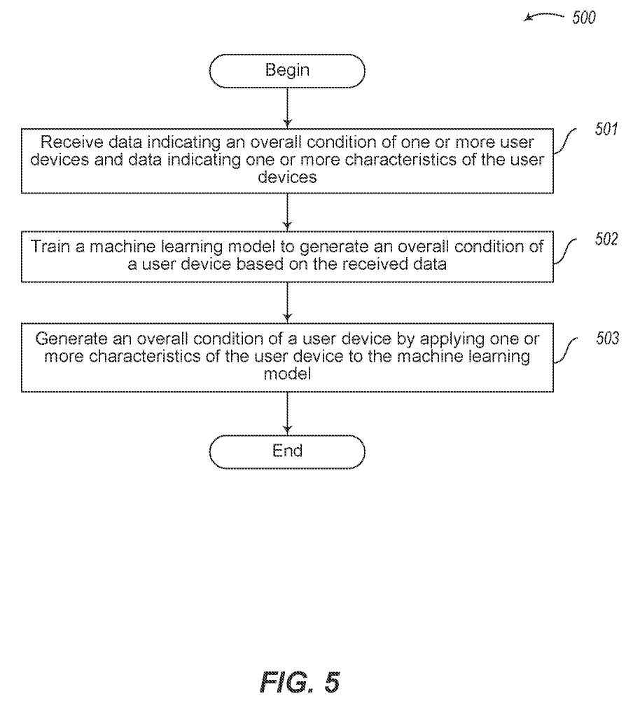

FIG. 5 is a flow diagram of a process 500 for using a machine learning model to generate an overall condition of a user device, according to various embodiments described herein. The process 500 may be performed by a user device evaluation system, such as the system 101 described above in connection with FIG. 2.

The process 500 begins, after a start block, at act 501, where the system receives data indicating an overall condition of one or more user devices and data indicating one or more characteristics of the user devices. In some embodiments, the data received in act 501 may be training data for a condition evaluation model, such as the condition evaluation model 225 described above in connection with FIG. 2. In some embodiments, the system may receive the data indicating the overall condition of one or more user devices and the data indicating one or more characteristics of the user devices multiple times, such as periodically, after a selected period of time, etc.

The process 500 proceeds to act 502, where the system trains a machine learning model to generate an overall condition of the user device based on the received data. In some embodiments, the trained machine learning model is a condition evaluation model, such as the condition evaluation model 225 described above in connection with FIG. 2.

The process 500 proceeds to act 503, where the system generates an overall condition of a user device by applying one or more characteristics of the user device to the machine learning model.

After act 503, the process 500 ends.

In some embodiments, the system retrains the machine learning model of the process 500. In such embodiments, the system may retrain the machine learning model in response to receiving new data indicating the overall condition of one or more user devices and one or more characteristics of the user devices.

In some embodiments, the system uses a formula generated based on statistical analysis instead of, or in addition to, the machine learning model. In such embodiments, at act 502, the system may generate the formula instead of, or in addition to, training the machine learning model.

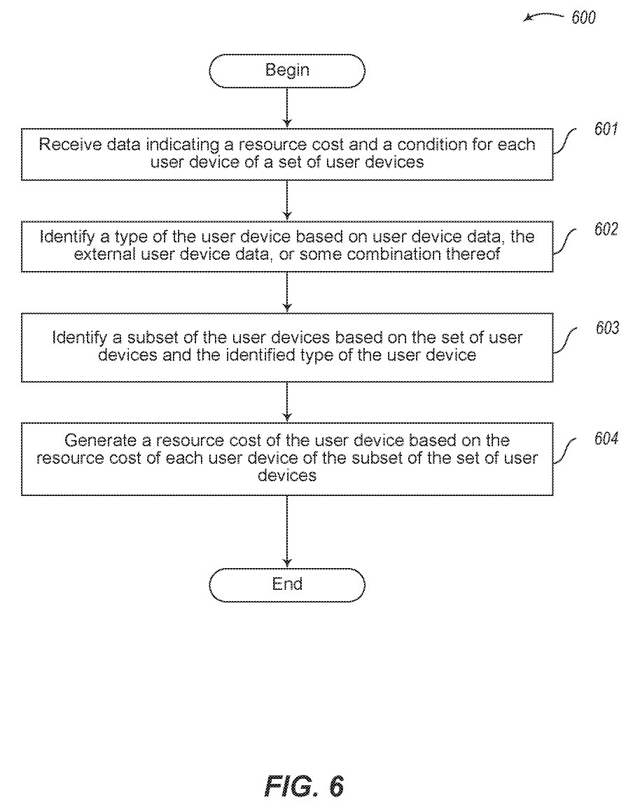

FIG. 6 is a flow diagram of a process 600 for determining a resource cost for a user device, according to various embodiments described herein. The process 600 may be performed by a user device evaluation system, such as the system 101 described above in connection with FIG. 2.

The process 600 begins, after a start block, at act 601, where the system receives data indicating a resource cost and one or more characteristics for each user device of a set of user devices. In some embodiments, the system performs act 601 in a similar manner to act 401, described above with respect to FIG. 4. In some embodiments, the data received in act 601 may include an indication of a device type for each user device of the set of user devices. In some embodiments, the “type” of a user device may include an indication of a manufacturer of the user device, a model of the user device, a one or more networks on which the user device can operate, other data used to identify a user device, or some combination thereof. In some embodiments, the data received in act 601 may indicate that at least one user device of the set of user devices was transferred to another user in exchange for resources that total the resource cost indicated in the data.

The process 600 proceeds to act 602, where the system identifies a type of a user device based on user device data, external user device data, or some combination thereof. In some embodiments, the user device data and external user device data may be received as part of the process 300, described above in connection with FIG. 3.

The process 600 proceeds to act 603, where the system identifies a subset of the user devices based on the set of user devices and the identified type of the user device.

The process 600 proceeds to act 604, where the system generates a resource cost for the user device based on the resource cost of each user device of the subset of the set of user devices. In some embodiments, the system generates the resource cost based on the one or more characteristics of the user device, the type of the user device, the resource cost of each user device of the subset of user devices, one or more characteristics of each user device of the subset of user devices, or some combination thereof. In some embodiments, the system uses statistical analysis to generate the resource cost for the user device. For example, the system may aggregate the resource costs for user devices in the subset of the set of user devices that have similar conditions to the conditions of the user device. In such an example, the system may use the aggregated resource cost to determine the resource cost for the user device. In some embodiments, where the data indicates that at least one user device of the set of user devices was transferred to another user in exchange for resources that total the resource cost indicated in the data, the data indicating that the user device was transferred in exchanged for resources that total the resource cost may be weighted such that it affects the generated resource cost greater than or less than the other resource costs included in the data received in act 601.

After act 604, the process 600 ends.

In some embodiments, the system may generate an updated resource cost for the user device based on additional data indicating a resource cost and one or more characteristics for each user device of a set of user devices. In some embodiments, the system receives the additional data multiple times, such as after a selected time period, periodically, etc. In some embodiments, the system may use the updated resource cost to update a description of the user device.

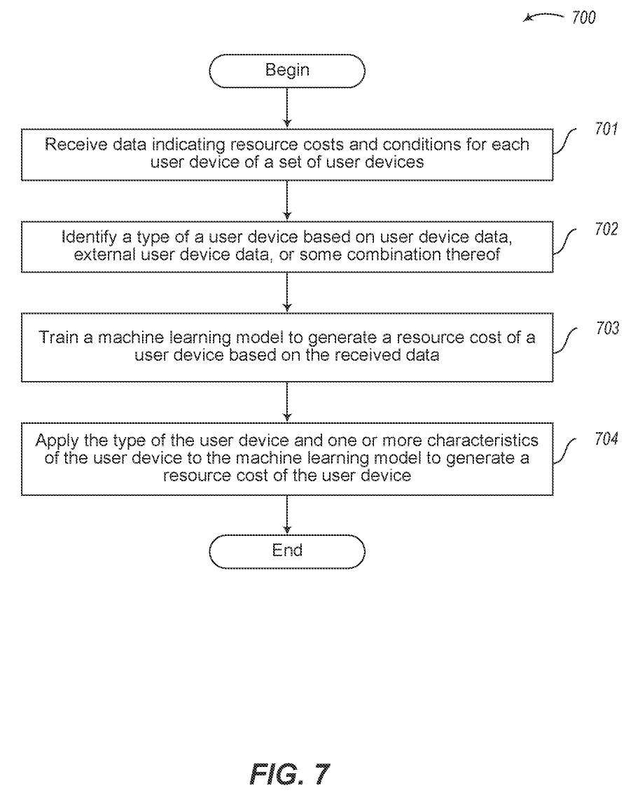

FIG. 7 is a flow diagram of a process 700 for using a machine learning model to determine a resource cost for a user device, according to various embodiments described herein. The process 700 may be performed by a user device evaluation system, such as the system 101 described above in connection with FIG. 2.

The process 700 begins, after a start block, at act 701, where the system receives data indicating resource costs and conditions for each user device of a set of user devices. In some embodiments, the system performs act 701 in a similar manner to act 601, described above in connection with FIG. 6.

The process 700 proceeds to act 702, where the system identifies a type of a user device based on user device data, external user device data, or some combination thereof. In some embodiments, the user device data and external user device data may be received as part of the process 300, described above in connection with FIG. 3.

The process 700 proceeds to act 703, where the system trains a machine learning model to generate a resource cost of a user device based on the data received in act 701. In some embodiments, the machine learning model is a resource cost determination model, such as the resource cost determination model 225 described above in connection with FIG. 2. In some embodiments, where the data indicates that at least one user device of the set of user devices was transferred to another user in exchange for resources that total the resource cost indicated in the data, the data indicating that the user device was transferred in exchanged for resources that total the resource cost may be weighted when used as training data for the machine learning model.

The process 700 proceeds to act 704, where the system applies the type of the user device and one or more characteristics of the user device to the machine learning model to generate a resource cost of the user device.

After act 704, the process 700 ends.

In some embodiments, the system may generate an updated resource cost for the user device based on additional data indicating a resource cost and one or more characteristics for each user device of a set of user devices. In some embodiments, the system receives the additional data multiple times, such as after a selected time period, periodically, etc. In some embodiments, the system may use the updated resource cost to update a description of the user device. In some embodiments, the system uses the additional data to retrain the machine learning model.

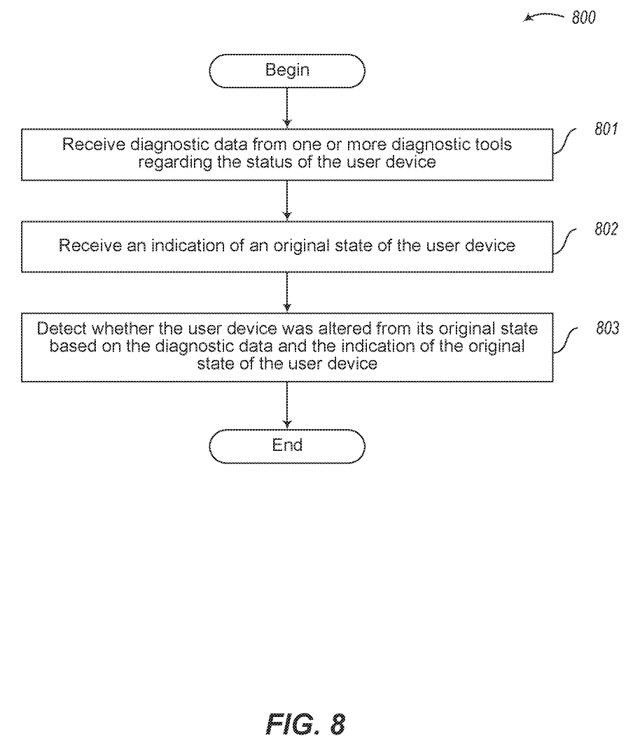

FIG. 8 is a flow diagram of a process 800 for detecting whether a user device was altered from its original state, according to various embodiments described herein. The process 800 may be performed by a user device evaluation system, such as the system 101 described above in connection with FIG. 2.

The process 800 begins, after a start block, at act 801, where the system receives diagnostic data from one or more diagnostic tools regarding the status of the user device. In some embodiments, the diagnostic tools may be device analysis tools, data erasure tools, other tools for receiving data regarding a condition of a user device or its components, or some combination thereof.

The process 800 proceeds to act 802, where the system receives an indication of an original state of the user device. In some embodiments, the system receives the indication of the original state of the user device from user device data, external user device data, or some combination thereof. In some embodiments, the indication of the original state of the user device includes an indication of one or more components originally included in the user device, software originally included in the user device, an operating system originally used by the user device, one or more networks originally accessible by the user device, or other indications of the original state of a user device.

The process 800 proceeds to act 803, where the system detects whether the user device was altered from its original state based on the diagnostic data and the indication of the original state of the user device. For example, the diagnostic data may indicate that the user device includes one or more components that were not originally included in the user device. In another example, the diagnostic data may indicate that the user device includes a different operating system from the original operating system included in the user device. In yet another example, the diagnostic data may indicate that the user device is able to access networks other than the one or more networks originally accessible by the user device.

After act 803, the process 800 ends.

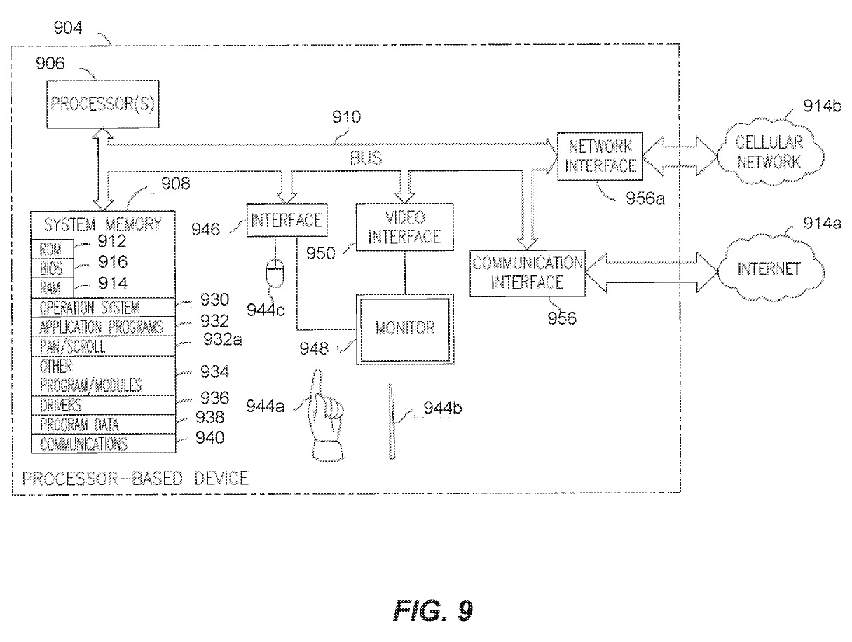

FIG. 9 shows a processor-based device 904 suitable for implementing the various functionality described herein. At least a portion of the operations, functionality, processes, and data described above in connection with the user device evaluation system may be used, stored, executed, etc., by the processor-based device 904. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based device 904 may include one or more processors 906, a system memory 908 and a system bus 910 that couples various system components including the system memory 908 to the processor(s) 906. The processor-based device 904 will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 906 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 9 are of conventional design. As a result, such blocks need not be described in further detail herein, as they will be understood by those skilled in the relevant art.

The system bus 910 can employ any known bus structures or architectures, including a memory bus with memory controller, a peripheral bus, and a local bus. The system memory 908 includes read-only memory (“ROM”) 912 and random access memory (“RAM”) 914. A basic input/output system (“BIOS”) 916, which can form part of the ROM 912, contains basic routines that help transfer information between elements within processor-based device 904, such as during start-up. Some implementations may employ separate buses for data, instructions and power.

The processor-based device 904 may also include one or more solid state memories, for instance Flash memory or solid state drive (SSD) 99, which provides nonvolatile storage of computer-readable instructions, data structures, program modules and other data for the processor-based device 904. Although not depicted, the processor-based device 904 can employ other nontransitory computer- or processor-readable media, for example a hard disk drive, an optical disk drive, or memory card media drive.

Program modules can be stored in the system memory 908, such as an operating system 930, one or more application programs 932, other programs or modules 934, drivers 936 and program data 938.

The application programs 932 may, for example, include panning / scrolling 932a. Such panning / scrolling logic may include, but is not limited to logic that determines when and/or where a pointer (e.g., finger, stylus, cursor) enters a user interface element that includes a region having a central portion and at least one margin. Such panning / scrolling logic may include, but is not limited to logic that determines a direction and a rate at which at least one element of the user interface element should appear to move, and causes updating of a display to cause the at least one element to appear to move in the determined direction at the determined rate. The panning / scrolling logic 932a may, for example, be stored as one or more executable instructions. The panning / scrolling logic 932a may include processor and/or machine executable logic or instructions to generate user interface objects using data that characterizes movement of a pointer, for example data from a touch-sensitive display or from a computer mouse or trackball, or other user interface device.

The system memory 908 may also include communications programs 940, for example a server and/or a Web client or browser for permitting the processor-based device 904 to access and exchange data with other systems such as user computing systems, Web sites on the Internet, corporate intranets, or other networks as described below. The communications programs 940 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 9 as being stored in the system memory 908, the operating system 930, application programs 932, other programs/modules 934, drivers 936, program data 938 and server and/or communications programs 940 can be stored on any other of a large variety of nontransitory processor-readable media (e.g., hard disk drive, optical disk drive, SSD and/or flash memory).

A user may enter commands and information via a pointer, for example through input devices such as a touch screen 948 via a finger 944a, stylus 944b, or via a computer mouse or trackball 944c which controls a cursor. Other input devices can include a microphone, joystick, game pad, tablet, scanner, biometric scanning device, etc. These and other input devices (i.e., “I/O devices”) are connected to the processor(s) 906 through an interface 946 such as touch-screen controller and/or a universal serial bus (“USB”) interface that couples user input to the system bus 910, although other interfaces such as a parallel port, a game port or a wireless interface or a serial port may be used. The touch screen 948 can be coupled to the system bus 910 via a video interface 950, such as a video adapter to receive image data or image information for display via the touch screen 948. Although not shown, the processor-based device 904 can include other output devices, such as speakers, vibrator, haptic actuator, etc.

The processor-based device 904 may operate in a networked environment using one or more of the logical connections to communicate with one or more remote computers, servers and/or devices via one or more communications channels, for example, one or more networks 914a, 914b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based device 904 may include one or more wired or wireless communications interfaces 914a, 914b (e.g., cellular radios, WI-FI radios, Bluetooth radios) for establishing communications over the network, for instance the Internet 914a or cellular network.

In a networked environment, program modules, application programs, or data, or portions thereof, can be stored in a server computing system (not shown). Those skilled in the relevant art will recognize that the network connections shown in FIG. 9 are only some examples of ways of establishing communications between computers, and other connections may be used, including wirelessly.

For convenience, the processor(s) 906, system memory 908, network and communications interfaces 914a, 914b are illustrated as communicably coupled to each other via the system bus 910, thereby providing connectivity between the above-described components. In alternative implementations of the processor-based device 904, the above-described components may be communicably coupled in a different manner than illustrated in FIG. 9. For example, one or more of the above-described components may be directly coupled to other components, or may be coupled to each other, via intermediary components (not shown). In some implementations, system bus 910 is omitted and the components are coupled directly to each other using suitable connections.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is :

1. A method of operating a computer system, comprising:
receiving user device data from a user device, the user device data including an identifier of the user device;
identifying, based on the user device data, one or more external user device data repositories, the external user device data repositories being data repositories that are not stored on the user device;
receiving external user device data from the one or more external user device data repositories based on the identifier of the user device;
determining one or more characteristics of the user device based on the user device data and the external user device data;
generating a description of the user device based on the one or more characteristics; and
causing the description of the user device to be presented to one or more users.

2. The method of claim 1, wherein the one or more characteristics comprise at least one of:
an indication of one or more networks that the user device is not able to access;
an indication of whether the user device was stolen;
an indication of a user that possessed the user device;
an indication of a status of one or more components of the user device;
an indication of a model of the user device; and
an indication of the overall condition of the user device.

3. The method of claim 1, further comprising:
identifying a model of the user device based on the user device data; and
determining whether the model identified based on the user device data is correct based on the external user device data.

4. The method of claim 1, further comprising:
identifying one or more entities that provide descriptions of user devices to users;
receiving, from the one or more entities, data indicating descriptions of one or more user devices and conditions of the one or more user devices; and
generating the description of the user device by applying the one or more characteristics of the user device to a machine learning model trained using the data indicating descriptions of one or more user devices and conditions of the one or more user devices.

5. The method of claim 1, wherein causing the description of the user device to be presented to one or more users further comprises:
transmitting the generated description to one or more entities that provide descriptions of user devices to users.

6. The method of claim 1, further comprising:
receiving data indicating an overall condition of one or more user devices and data indicating one or more characteristics of the one or more user devices; and
generating an overall condition of the user device by applying the one or more characteristics of the user device to a machine learning model trained using the data indicating an overall condition of one or more user devices and the data indicating one or more characteristics of the one or more user devices.

7. The method of claim 1, wherein generating the description further comprises:
receiving data indicating a resource cost and one or more characteristics of each user device of a set of user devices;
identifying a type of the user device based on the user device data and the external user device data;
identifying a subset of the set of user devices based on the identified type of the user device; and
generating a resource cost of the user device based on the one or more characteristics of the user device and the resource cost of each user device of the subset of the set of user devices.

8. The method of claim 1, further comprising:
receiving data indicating resource costs for a set of user devices and conditions of each user device of the set of user devices;
identifying a type of the user device based on the user device data and the external user device data;
training a machine learning model to generate a resource cost of a user device based on the data indicating resource costs for the set of user devices and conditions of each user device of the set of user devices; and
generating a resource cost of the user device by applying the identified type of the user device and the one or more characteristics of the user device to a machine learning model trained using the data indicating resource costs for a set of user devices and conditions of each user device of the set of user devices.

9. The method of claim 1, further comprising:
generating, based on the one or more characteristics of the user device, the user device data, and the external user device data, a health report comprising:
a status of one or more components of the user device; and
an indication of the extent to which the user device was used by a user.

10. The method of claim 1, wherein the external user device data includes at least one of:
an indication of a date that the user device was manufactured;
an indication of a date that one or more components of the user device were manufactured;
an indication of whether the user device was reported as lost;
an indication of whether the user device was reported as stolen;
an indication of a model number of the user device;
an indication of a carrier associated with the user device;
an indication of one or more networks accessible by the user device;
an indication of the status of one or more components of the user device; and
an indication of an extent to which the user device was used by a user of the user device.

11. The method of claim 1, further comprising:
connecting to the user device; and
receiving the user device data via the connection to the user device.

12. The method of claim 1, further comprising:
detecting whether the user device was altered from its original state, comprising:
receiving diagnostic data from one or more diagnostic tools regarding the status of the user device;
receiving an indication of an original state of the user device; and
detecting that the user device was altered from its original state based on the diagnostic data and the indication of the original state of the user device.

13. A system comprising:
at least one processor; and
at least one memory coupled to the at least one processor, the at least one memory having computer-executable instructions stored thereon that, when executed by the at least one processor, cause the system to:
receive user device data from a user device, the user device data including an identifier of the user device;
identify, based on the user device data, one or more external user device data repositories, the external user device data repositories being data repositories that are not stored on the user device;
receive external user device data from the one or more external user device data repositories based on the identifier of the user device;
determine one or more characteristics of the user device based on the user device data and the external user device data;
generate a description of the user device based on the one or more characteristics; and
cause the description of the user device to be presented to one or more users.

14. The system of claim 13, wherein the computer-executable instructions further cause the at least one processor to:
identify a model of the user device based on the user device data; and
determine whether the model identified based on the user device data is correct based on the external user device data.

15. The system of claim 13, wherein the computer-executable instructions further cause the at least one processor to:
identify one or more entities that provide descriptions of user devices to users;
receive, from the one or more entities, data indicating descriptions of one or more user devices and conditions of the one or more user devices; and
generate the description of the user device by applying the one or more characteristics of the user device to a trained machine learning model, the machine learning model being trained based on the data indicating descriptions of one or more user devices and conditions of the one or more user devices.

16. The system of claim 13, wherein the computer-executable instructions further cause the at least one processor to:
receive data indicating an overall condition of one or more user devices and data indicating one or more characteristics of the one or more user devices; and
generate an overall condition of the user device by applying the one or more characteristics of the user device to a trained machine learning model, the machine learning model being trained based on the data indicating an overall condition of one or more user devices and the data indicating one or more characteristics of the one or more user devices.

17. The system of claim 13, wherein the computer-executable instructions further cause the at least one processor to:
receive data indicating resource costs for a set of user devices and conditions of each user device of the set of user devices;
identify a type of the user device based on the user device data and the external user device data; and
generate the resource cost of the user device by applying the identified type of the user device and the one or more characteristics of the user device to a trained machine learning model, the machine learning model being trained based on the data indicating resource costs for a set of user devices and conditions of each user device of the set of user devices.

18. The system of claim 13, wherein the computer-executable instructions further cause the at least one processor to:
generate, based on the one or more characteristics of the user device, the user device data, and the external user device data, a health report comprising:
a status of one or more components of the user device; and
an indication of the extent to which the user device was used by a user.

19. The system of claim 13, wherein the computer-executable instructions further cause the at least one processor to:
connect to the user device; and
receive the user device data via the connection to the user device.

20. A nontransitory computer-readable storage medium that stores at least one of instructions or data, the instructions or data, when executed by at least one processor, cause the at least one processor to:
receive user device data from a user device, the user device data including an identifier of the user device;
identify, based on the user device data, one or more external user device data repositories, the external user device data repositories being data repositories that are not stored on the user device;
receive external user device data from the one or more external user device data repositories based on the identifier of the user device;
determine one or more conditions of the user device based on the user device data and the external user device data;
generate a description of the user device based on the one or more conditions; and
cause the description of the user device to be presented to one or more users.
